(19) United States
(12) Patent Application Publication
(10) Pub. No.: US 2026/0287254 A1
(43) Pub. Date: Sep. 24, 2026

(54) AIR CIRCULATING DRYING TOWER FOR YOGA MAT

(71) Applicant: Christopher Alan Place, Lebanon, OH (US)

(72) Inventor: Christopher Alan Place, Lebanon, OH (US)

(21) Appl. No.: 19/084,180

(22) Filed: Mar. 19, 2025

(51) Int. Cl. F26B 25/14

(52) U.S. Cl. CPC F26B 25/14

(57) ABSTRACT

An apparatus for drying and storing yoga mats is disclosed, featuring a drying tower with an interior chamber, an open bottom, and a ventilated lid. The apparatus includes a yoga mat roll receptacle to secure the mat, a fan to draw air through the chamber, and an activated carbon insert to absorb moisture and odors. An electric timer controls the drying cycle. The design accommodates various mat sizes and purifies incoming air, offering a compact and efficient solution for drying and storing yoga mats.

### BACKGROUND OF THE INVENTION

Yoga mats serve as important tools for practitioners, designed to provide comfort and support during exercise. However, these mats often absorb sweat and moisture, leading to prolonged drying times. This can result in the growth of bacteria and the development of unpleasant odors, posing hygiene concerns for users. Traditional methods of drying, such as hanging or laying the mats out, require significant space and time, which may not be practical for individuals with limited living areas or busy schedules.

Existing solutions fail to address the need for a compact and efficient drying method that also facilitates easy storage. The lack of a dedicated apparatus for drying yoga mats means users often rely on makeshift solutions that are frequently ineffective and inconvenient. This highlights the need for an innovative approach that can quickly and effectively dry yoga mats while also providing a convenient storage solution.

These and other features, aspects and advantages of the present invention will become better understood with reference to the following drawings, description and claims.

### SUMMARY OF THE INVENTION

In one aspect of the present invention, there is disclosed an apparatus for drying and storing a yoga mat, comprising a drying tower having an interior chamber defined by four enclosed sidewalls, an open bottom, and a ventilated lid; a yoga mat roll receptacle configured to secure a rolled yoga mat within the interior chamber such that the rolled yoga mat forms spaced channels for air circulation; a fan positioned adjacent the open bottom and operable to draw ambient air upwardly through the interior chamber; an activated carbon insert disposed within the interior chamber to absorb moisture and odors; and an electric timer operatively connected to the fan to control a drying cycle.

In another embodiment, the drying tower includes adjustable sidewalls to accommodate different sizes of yoga mats; the ventilated lid is equipped with a filter to purify the air entering the chamber; and the yoga mat roll receptacle includes adjustable clamps or straps to secure yoga mats of varying thicknesses.

In a third embodiment, the receptacle is designed to rotate, allowing for even air distribution around the mat; the fan includes multiple speed settings to adjust airflow based on drying requirements; and the fan includes a noise reduction feature for quieter operation.

In a fourth embodiment, the activated carbon insert is replaceable or refillable to maintain effectiveness over time.

In a fifth embodiment, the present invention includes a method for drying and storing a rolled yoga mat, comprising providing a drying tower having an interior chamber defined by four enclosed sidewalls, an open bottom, and a ventilated lid; inserting a rolled yoga mat into the drying tower via a yoga mat roll receptacle configured to secure the rolled yoga mat such that spaced channels for air circulation are formed; positioning a fan adjacent the open bottom of the drying tower and operating the fan to draw ambient air upwardly through the interior chamber; disposing a replaceable activated carbon insert within the interior chamber to absorb moisture and odors; and connecting an electric timer to the fan and activating the timer to initiate a drying cycle that dries the yoga mat within a shortened time period while the yoga mat is stored in the tower.

These and other features, aspects and advantages of the present invention will become better understood with reference to the following drawings, description and claims.

### BRIEF DESCRIPTION OF THE DRAWINGS

FIG. 1 is a perspective view of the air circulating drying tower for a yoga mat constructed in accordance with a preferred embodiment of the present invention;

FIG. 2 is a system diagram illustrating the air circulating drying tower for a yoga mat, showcasing certain of the primary components and configuration of the tower;

FIG. 3 is a partial top perspective view illustrating the air circulating drying tower for a yoga mat with certain of the primary components of the tower;

FIG. 4 is a top view of an air circulating drying tower for a yoga mat in accordance with a preferred embodiment of the present invention; and

FIG. 5 is a side view of an air circulating drying tower for a yoga mat in accordance with a preferred embodiment of the present invention, showcasing airflow through the ventilated lid and fan.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Yoga mats serve as important tools for practitioners, offering comfort and support during exercise routines. However, these mats tend to absorb sweat and moisture, which can result in extended drying times. This moisture retention fosters an environment that encourages bacterial growth and the development of unpleasant odors, raising notable hygiene concerns for users. The difficulty of drying yoga mats is further increased by their size, which makes finding sufficient space for hanging or laying them out to dry challenging.

Existing solutions for drying yoga mats are often inadequate, as they typically involve makeshift methods such as hanging the mats over furniture or laying them flat on the floor. These approaches require considerable space and time, which may not be practical for individuals with limited living areas or busy schedules. Additionally, these methods do not facilitate efficient air circulation, resulting in uneven drying and potential damage to the mat over time. The lack of a dedicated apparatus for drying yoga mats highlights the need for an innovative solution that addresses these shortcomings.

The present invention provides a novel solution designed to efficiently dry and store yoga mats. This apparatus features a drying tower with an interior chamber defined by four enclosed sidewalls, an open bottom, and a ventilated lid. A yoga mat roll receptacle is configured to secure a rolled yoga mat within the interior chamber, forming spaced channels for air circulation. A fan positioned adjacent to the open bottom draws ambient air upwardly through the chamber, enhancing the drying process. Additionally, an activated carbon insert is included to absorb moisture and odors, while an electric timer controls the drying cycle, ensuring the mat is dried within a shortened time period. This compact and efficient design offers a practical solution for both drying and storing yoga mats, accommodating various mat sizes and purifying incoming air.

The apparatus for drying and storing a yoga mat of the present invention offers a compact and efficient solution by utilizing a drying tower with an interior chamber defined by four enclosed sidewalls, an open bottom, and a ventilated lid. The configuration of the yoga mat roll receptacle within the interior chamber ensures that the rolled yoga mat forms spaced channels, which facilitate optimal air circulation. This arrangement allows ambient air, drawn upwardly by the fan positioned adjacent to the open bottom, to circulate effectively through the mat, significantly reducing drying time compared to traditional methods. The inclusion of an activated carbon insert within the chamber serves to absorb moisture and odors, enhancing the drying process and maintaining hygiene by preventing bacterial growth and unpleasant smells. The electric timer operatively connected to the fan allows for precise control of the drying cycle, ensuring the mat is dried efficiently within a predetermined time frame. This design not only addresses the space constraints associated with drying yoga mats but also provides a convenient storage solution, making the apparatus particularly advantageous for users with limited living areas or busy schedules.

In one embodiment, the drying tower is constructed from lightweight, durable materials such as aluminum or high-density polyethylene, allowing for easy transport and resistance to moisture. The sidewalls of the tower may be designed to be collapsible or telescopic, enabling the apparatus to accommodate yoga mats of varying lengths and thicknesses.

In another embodiment, the fan positioned at the bottom of the tower could be a variable-speed fan, allowing users to adjust the airflow based on the humidity level or the thickness of the mat. The fan may also include a noise-canceling feature to ensure quiet operation. The activated carbon insert, in one embodiment, could be integrated into a removable cartridge system, allowing for easy replacement or recharging of the carbon material. Additionally, the electric timer could be a digital interface with programmable settings, enabling users to customize drying cycles according to their preferences.

The yoga mat roll receptacle might include adjustable clamps or elastic straps to securely hold mats of different sizes, and in some embodiments, the receptacle could be designed to rotate, ensuring even air distribution around the mat for more efficient drying. The ventilated lid could be equipped with a HEPA filter to purify the air entering the chamber, enhancing the drying process by reducing contaminants.

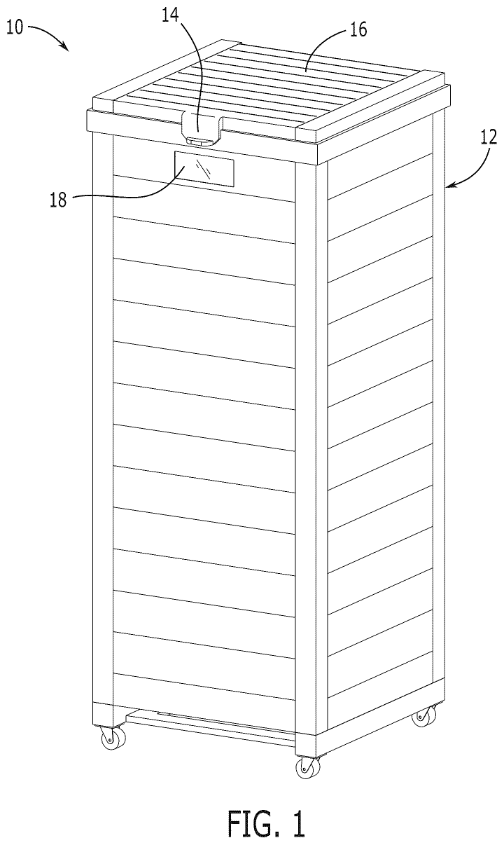

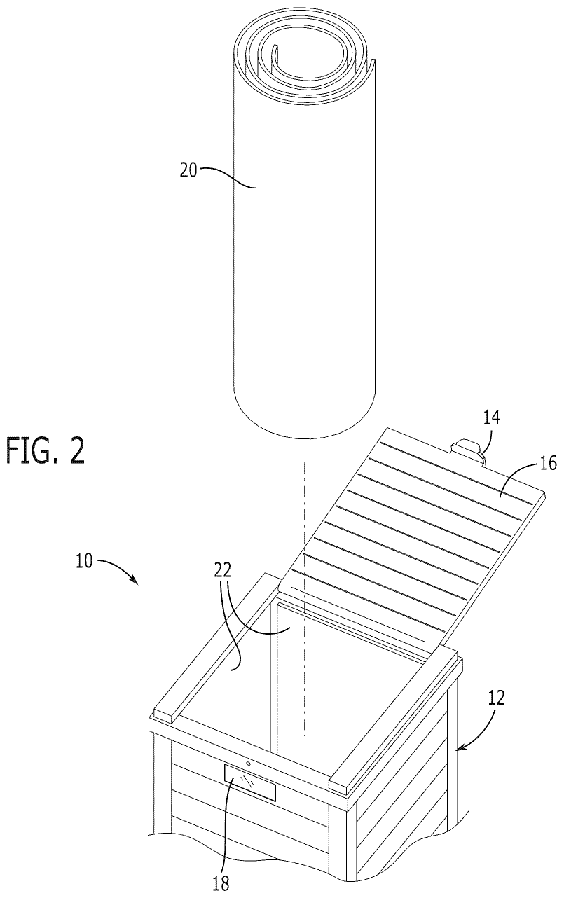

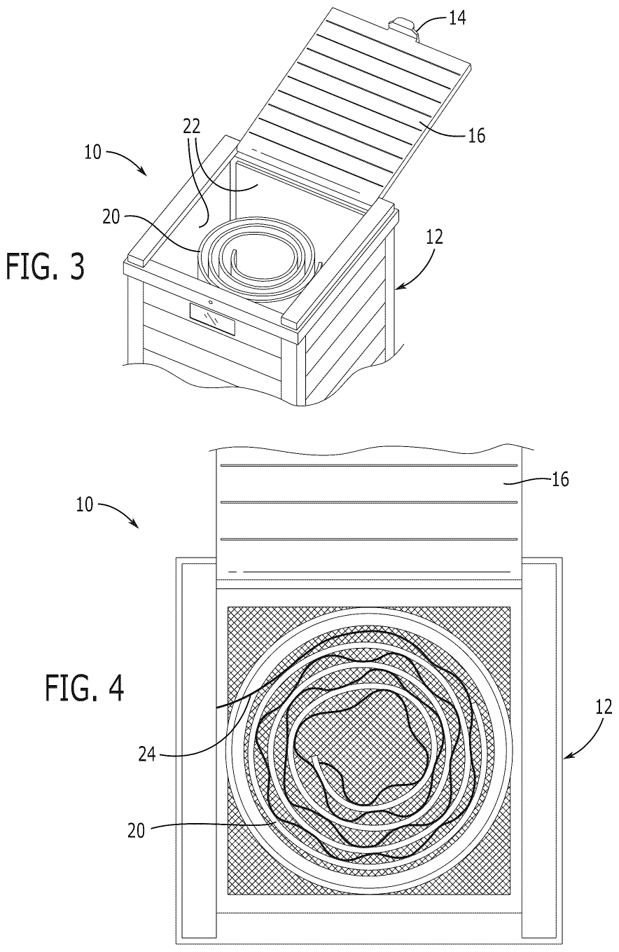

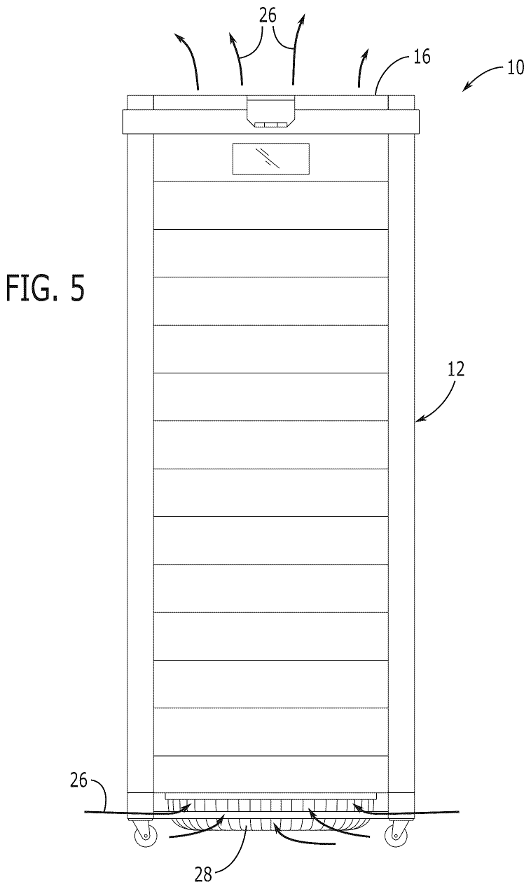

The air circulating drying tower for a yoga mat 10 is an innovative apparatus designed to efficiently dry and store yoga mats. As seen in FIGS. 1-5, the drying tower 12 forms the central structure of the apparatus, providing an interior chamber defined by four enclosed sidewalls, an open bottom, and a ventilated lid 16. This configuration allows for optimal air circulation within the chamber, facilitating the drying process. The drying tower 12 is constructed from lightweight, durable materials such as aluminum or high-density polyethylene, which ensures easy transport and resistance to moisture. The sidewalls of the tower may be adjustable to accommodate different sizes of yoga mats, enhancing the versatility of the apparatus. The drying tower 12 is designed to allow for optimal airflow throughout the tower and has a mode to lock the structure in for drying and unlocked for simple storage.

The locking latch 14 ensures that the ventilated lid 16 remains securely closed during the drying process. This feature is important for maintaining the internal environment of the tower, preventing the escape of moisture-laden air and allowing the fan 28 to circulate air through the interior chamber efficiently. The locking latch 14 offers a straightforward yet effective mechanism for users to secure the lid, enhancing the overall usability and safety of the apparatus.

The ventilated lid 16 facilitates the upward movement of air through the interior chamber. The lid is equipped with ventilation openings that allow air to exit the chamber, ensuring continuous airflow around the yoga mat 20. In some embodiments, the ventilated lid 16 may include a filter to purify the air entering the chamber, further enhancing the drying process by reducing contaminants. The lid's design ensures that the drying process is efficient and that the mat is exposed to a consistent flow of air, reducing drying time and preventing the growth of bacteria and odors.

The timer/control screen 18 is operatively connected to the fan 28 and serves as the user interface for controlling the drying cycle. This component allows users to set a desired drying time, ensuring that the yoga mat 20 is dried within a predetermined period. The timer/control screen 18 may feature a digital interface with programmable settings, enabling users to customize drying cycles according to their preferences. This feature provides precise control over the drying process, enhancing the efficiency and convenience of the apparatus.

The yoga mat 20 is placed within the drying tower 12, where the mat is secured by a yoga mat roll receptacle configured to form spaced channels for air circulation. This arrangement ensures that air can flow freely around the mat, significantly reducing drying time compared to traditional methods. The yoga mat 20 is designed to be rolled and inserted into the tower 12, allowing for easy storage and transport. The configuration of the mat 20 within the tower 12 helps optimize airflow and ensuring even drying.

The activated carbon inserts 22 are disposed within the interior chamber of the drying tower 12, serving to absorb moisture and odors during the drying process. These inserts enhance the drying process by maintaining hygiene and preventing the growth of bacteria and unpleasant smells. In some embodiments, the activated carbon inserts 22 may be replaceable or refillable, ensuring their effectiveness over time. This feature provides an additional layer of functionality, contributing to the overall efficiency and effectiveness of the apparatus.

The yoga roll carrier 24 serves as an accessory that aids in the insertion and removal of the yoga mat 20 from the drying tower 12. This component is crafted to securely hold the rolled mat, ensuring the mat remains in the most suitable position for drying. The yoga roll carrier 24 may feature adjustable clamps or straps to accommodate mats of different thicknesses, enhancing the versatility of the apparatus. In certain embodiments, the carrier may be designed to rotate, allowing for even air distribution around the mat.

The airflow 26 within the drying tower 12 is generated by the fan 28, which is positioned adjacent to the open bottom of the tower. The fan 28 is operable to draw ambient air upwardly through the interior chamber, facilitating the drying process. The airflow 26 plays an important role in ensuring that air circulates effectively through the mat and that moisture is efficiently removed. The fan 28 may include multiple speed settings to adjust airflow based on drying requirements, and in some embodiments, the fan may feature a noise reduction feature for quieter operation. The placement of the fan 28 at the bottom of the tower allows the fan to pull air easily from the room, maintaining optimal airflow within the tower.

It should be understood, of course, that the foregoing relates to exemplary embodiments of the invention and that modifications may be made without departing from the spirit and scope of the invention as set forth in the following claims.

What is claimed is:

1. An apparatus for drying and storing a yoga mat, comprising:
a drying tower having an interior chamber defined by four enclosed sidewalls, an open bottom, and a ventilated lid;
a yoga mat roll receptacle configured to secure a rolled yoga mat within the interior chamber such that the rolled yoga mat forms spaced channels for air circulation;
a fan positioned adjacent the open bottom and operable to draw ambient air upwardly through the interior chamber;
an activated carbon insert disposed within the interior chamber to absorb moisture and odors; and
an electric timer operatively connected to the fan to control a drying cycle.

2. The apparatus of claim 1, wherein the drying tower includes adjustable sidewalls to accommodate different sizes of yoga mats.

3. The apparatus of claim 2, wherein the ventilated lid is equipped with a filter to purify the air entering the chamber.

4. The apparatus of claim 1, wherein the yoga mat roll receptacle includes adjustable clamps or straps to secure yoga mats of varying thicknesses.

5. The apparatus of claim 4, wherein the receptacle is designed to rotate, allowing for even air distribution around the mat.

6. The apparatus of claim 1, wherein the fan includes multiple speed settings to adjust airflow based on drying requirements.

7. The apparatus of claim 6, wherein the fan includes a noise reduction feature for quieter operation.

8. The apparatus of claim 1, wherein the activated carbon insert is replaceable or refillable to maintain effectiveness over time.

9. A method for drying and storing a rolled yoga mat, comprising:
providing a drying tower having an interior chamber defined by four enclosed sidewalls, an open bottom, and a ventilated lid;
inserting a rolled yoga mat into the drying tower via a yoga mat roll receptacle configured to secure the rolled yoga mat such that spaced channels for air circulation are formed;
positioning a fan adjacent the open bottom of the drying tower and operating the fan to draw ambient air upwardly through the interior chamber;
disposing a replaceable activated carbon insert within the interior chamber to absorb moisture and odors; and
connecting an electric timer to the fan and activating the timer to initiate a drying cycle that dries the yoga mat within a shortened time period while the yoga mat is stored in the tower.
